(19) United States
(12) Patent Application Publication
(10) Pub. No.: US 2024/0361284 A1
(43) Pub. Date: Oct. 31, 2024

(54) OVEN FOR AN ANALYSIS SYSTEM, TITRATION SYSTEM AND TITRATION METHOD

(71) Applicant: Metrohm AG, Herisau (CH)

(72) Inventors: Adrian EKKELS, Gossau (CH); Alwin BÜCHLER, Speicherschwendi (CH); Gabriel LOPEZ, St. Gallen (CH)

(73) Assignee: Metrohm AG, Herisau (CH)

(21) Appl. No.: 18/684,218

(22) PCT Filed: Aug. 23, 2022
(86) PCT No.: PCT/EP2022/073412

§ 371 Date: Feb. 16, 2024

(30) Foreign Application Priority Data
Aug. 26, 2021 (EP) 21193337.9

(51) Int. Cl. G01N 31/16; F27B 17/02; G01N 35/00; H05B 3/62

(52) U.S. Cl. CPC G01N 31/168; F27B 17/02; G01N 35/0099; H05B 3/62; G01N 2035/00356

(57) ABSTRACT

The invention relates to an oven (1, 1′) for an analytical system, in particular for a titration system and especially for a Karl Fischer titration system. The oven (1, 1′) comprises a housing, an insulation system (2a, 2a′, 2b, 2b′, 2c, 2c′) and an insert (3, 3′) for a sample vessel. The insulation system (2a, 2a′, 2b, 2b′, 2c, 2c′) is arranged at least partially around the insert (3, 3′). At least one heating element is arranged between the insulation system (2a, 2a′, 2b, 2b′, 2c, 2c′) and the insert (3, 3′) and at least partially surrounding the insert (3, 3′). The invention also relates to a titration system with such an oven (1, 1′) and a titration method.

The invention relates to an oven for an analysis system, in particular for a titration system, a titration system with such an oven and a titration method.

The use of ovens is known in the prior art, particularly in connection with titration systems and especially with Karl Fischer titration. The oven enables thermal sample preparation for samples that cannot be titrated directly. This can be the case, for example, if the sample is poorly soluble, the water can only be released at high temperatures, or the sample reacts with the Karl Fischer (KF) reagent. In the oven method, the samples are heated, and the released water is transferred to the titration cell using a dry carrier gas. As only the water comes into contact with the KF reagent, contamination of the electrode and titration cell is avoided and carry-over and memory effects, which could falsify the result, are ruled out.

Common ovens currently available on the market have the disadvantage that the waiting time until the set temperature is reached is relatively long. Solid metal blocks, which are heated with heating cartridges, react very slowly to temperature changes due to their thermal capacity. In addition, heating up the ovens currently in use requires a lot of energy. The ovens also lack compactness.

EP3441757 A1 describes an oven arrangement for a Karl Fischer titration system. The oven arrangement has a ventilation system for cooling the housing. An insulation system prevents heat loss during the heating phase.

It is a task of the invention to overcome the disadvantages of the prior art. In particular, it is a task of the invention to provide an oven for an analytical system which enables rapid and efficient sample heating with low energy consumption. It is also a task of the invention to provide a compact oven. It is further a task of the invention to provide a titration system with such an oven as well as a titration method.

The tasks are solved by the independent claims. Particular embodiments can be found in the dependent claims.

A first aspect of the invention relates to an oven for an analytical system, in particular for a titration system and more particularly for a Karl Fischer titration system. The oven comprises a housing, an insulation system and an insert for a sample vessel. The insulation system is arranged at least partially around the insert. At least one heating element is arranged between the insulation system and the insert and at least partially surrounding the insert.

Preferably, the at least one heating element is clamped to the insert by internal tension. Notches in the wall of the insert, in which the at least one heating element is positioned or can be positioned, are also conceivable.

Such an oven is characterized by the fact that the at least one heating element can be brought particularly close to the sample and thus enables particularly fast and efficient heating of the sample. This also makes it possible to reduce the energy requirement compared to known ovens.

The housing can be formed by the insulation system or additionally enclose the insulation system in the form of an outer shell. The insulation system can comprise two side half shells and a base insulation. However, it is also possible to design the side insulation in one piece. Preferably, the insulation material has a thermal conductivity of less than 0.5 W/(m * K). The insulation system is therefore preferably a thermal insulation system. For example, the insulation material can be made of the insulating material WDS Ultra (e.g. from Morgan Advanced Materials PLC), a mineral microporous insulation material made of inorganic silicate substances. The insulation material can also be coated with aluminum, for example with an aluminum adhesive tape. Pyrogel is also possible.

The at least one heating element can be a tubular cartridge. The tubular cartridge can have a thermocouple. Optionally, the thermocouple can be a separate temperature sensor or a temperature sensor integrated into the tubular cartridge.

The tubular cartridge can be arranged in a spiral around the insert. Preferably, only one tubular cartridge is used in the case of a spiral tubular cartridge. The tubular cartridge can be wound with 7 to 8 turns around an insert for sample vessels with a volume of 6 mL and 8 mL.

Tubular cartridges have the advantage that they are available as standard and are easy to handle. Tubular cartridges are available in variable designs and custom-made tubular cartridges can also be easily realized. The spiral arrangement enables optimum heating of the insert, bringing it as close as possible to the sample.

However, it is also possible to position several heating cartridges in a vertical arrangement around the insert and feed them via a common connection. Heating mats or micanite surface heating elements can also be used. The heating element used should above all be able to generate the temperature required for sample preparation and/or analysis. Heating mats, for example, are less suitable for high temperatures around 300° C.

The insert preferably has an inner diameter of between 16 mm and 31 mm, particularly preferably 22 mm to 24 mm. Typically, an insert for a 6 mL sample vessel can have an inner diameter of 22.45 mm. An insert for an 8 mL sample vessel can have an inner diameter of 23.25 mm, for example.

The insert has the advantage that it is or can be optimally adapted to the sample vessels. This enables particularly efficient and rapid heating. Spaces between the insert and sample vessel are minimized.

The oven can have an outer diameter of between 60 and 62 mm and preferably 61 mm.

Vials, which are usually sealed with a septum, are typically used as sample containers.

Regardless of the vial size, the outer diameter advantageously remains constant. Adjustment to different vial sizes can be made, for example, via the thickness of the wall of the insulation.

The oven can have an external height of between 50 and 90 mm, preferably 51 and 88 mm and particularly preferably 55 and 56 mm, and an internal height of the insert in the range of 28 to 60 mm and preferably 33 mm.

The oven is characterized by its particularly compact design. The small installation space allows it to be placed almost anywhere and also enables existing systems to be retrofitted, for example. It is also possible to use two ovens per analyzer.

The oven size for standard vial sizes can, for example, have the following oven dimensions:

Oven size

| | | Internal | | External |
|---|---|---|---|---|
| Vial size | Inner Ø | height | Outer Ø | height |
| 2 mL | 16.75 mm | 28.5 mm | 61.0 mm | 51.0 mm |
| 6 mL | 22.45 mm | 33.0 mm | 61.0 mm | 55.5 mm |
| 8 mL | 23.25 mm | 33.0 mm | 61.0 mm | 55.5 mm |
| 30 mL | 30.75 mm | 65.5 mm | 61.0 mm | 88.0 mm |

The insert can be made of a thermally conductive material, preferably with a thermal conductivity higher than 10 W/(m K).

The thermally conductive material can be brass, silver, aluminum (up to 250° C.), stainless steel, carbon-filled PEEK or ceramic, for example. Brass is particularly preferred. Stainless steel is of particular interest in terms of its chemical resistance. This list is not exhaustive. In principle, all materials with suitable thermal conductivity are conceivable.

Material with high thermal conductivity enables particularly efficient heating of the sample.

The insert can have a temperature sensor. Preferably, the temperature sensor is attached to or incorporated in a wall of the insert. The wall of the insert can be very thin and have a wall thickness of 1 mm to 3 mm, preferably 2 mm to 2.5 mm and most preferably 2.3 mm. The sensor thus fits straight into the wall and enables the most precise measurement possible, which is not distorted by excessive wall thickness. However, as described above, it is also possible for the temperature sensor to be an integral part of the tubular cartridge.

On the one hand, the thin wall thickness of the insert reduces the amount of material required and, on the other, the temperature in the insert can be determined quickly and precisely.

Advantageously, the oven can have a temperature protection switch, and this can preferably be arranged below the insert. However, another positioning of the switch is also conceivable. Positioning below the insert is preferred due to the space available.

The temperature protection switch prevents the sample and/or the system from overheating, thus ensuring reliable and long-lasting operation.

A further aspect of the invention relates to a titration system, in particular a Karl Fischer titration system. The titration system comprises at least one oven as described above.

However, the titration system is not limited to Karl Fischer, but can be any volumetric or coulometric titration system.

For a fast sample throughput, it is also possible to equip the titration system with two ovens as described above.

Preferably, the titration system also has a sample changer and comprises at least one first transfer system for transferring a sample from a sample rack to the at least one oven. The transfer system can, for example, be an automatic lift system or a gripper arm or arm of a sample robot.

With a sample changer, several samples can be handled in one continuous operation.

Advantageously, the titration system may comprise at least a second transfer system for transferring a sample from the oven to a titration cell.

For example, the at least second transfer system can comprise a double hollow needle with an inlet needle and an exhaust needle, a carrier gas flow and a heated transfer tube. The sample is preferably located in a sample vessel, for example in a vial sealed with a septum, in the oven.

Such a transfer system makes it possible to transfer only gaseous components of the sample into the titration cell and to prevent side reactions between other components of the sample and the titration reagents.

The system can be at least partially automated, preferably fully automated.

An at least partially automated system is characterized by a continuous and therefore fast mode of operation. Samples can therefore be analyzed more quickly. In addition, the operating procedures can be better controlled, which improves reproducibility and accuracy.

A third aspect of the invention relates to a titration method, preferably a Karl Fischer titration method. The method comprises the steps of:
Providing a titration system as described above,
Providing a sample,
Heating the sample with an oven as described above,
Titration of the sample.

The water content of a sample is preferably determined using the titration method.

In detail, the procedure can be carried out as follows: The sample or substance to be analyzed can be weighed into a vial, tightly sealed and positioned in the oven in this way. The sample can be heated in the oven so that, for example, water can be released. A needle, preferably a double hollow needle, pierces the septum of the vial or vessel and carrier gas flow, e.g. air or inert gas, is passed through the heated sample. The carrier gas loaded with the expelled moisture flows through the exhaust needle into the titration cell via a heated transfer tube. In the titration cell, the concentration of the water can be determined by means of coulometric or volumetric titration.

In this way, only the water enters the titration cell, so that side reactions of other substances contained in the sample with the titration reagents can be avoided. It is understood that the method is not limited to the determination of water but can in principle be carried out for any heatable sample.

The invention is explained in more detail below using an example embodiment. The example embodiment is not to be understood as limiting. It shows:

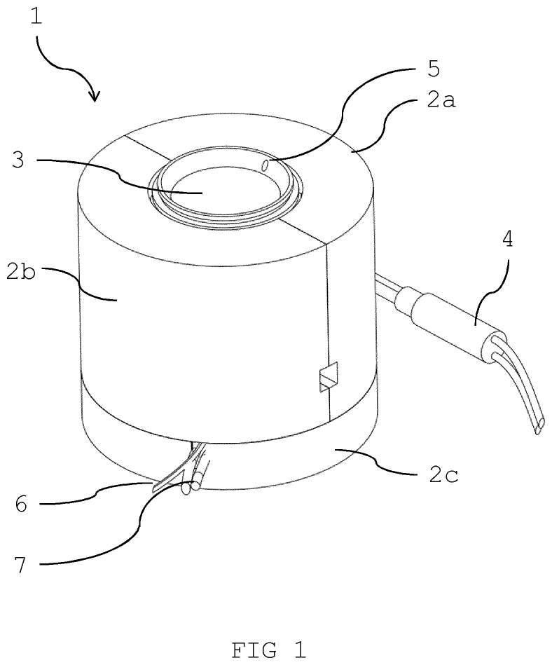

FIG. 1: An oven according to the invention with lateral insulation,

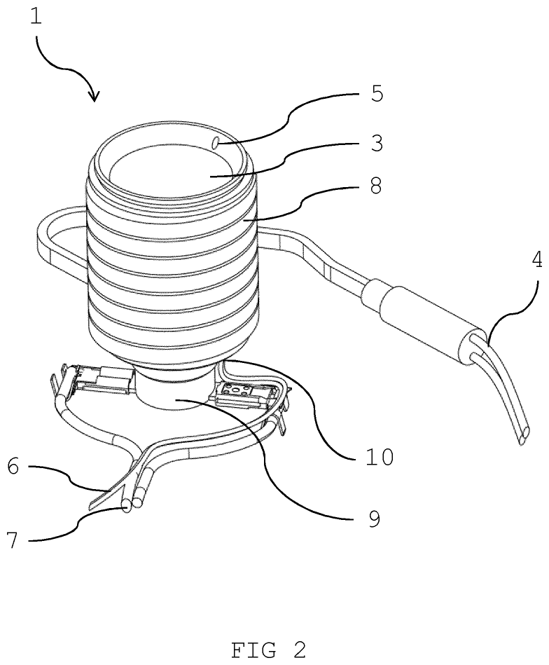

FIG. 2: the oven according to the invention from FIG. 1 without lateral insulation.

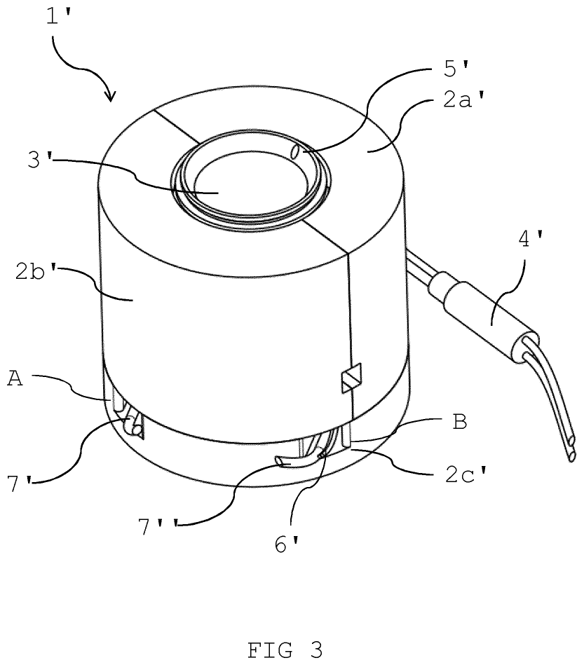

FIG. 3: an alternative embodiment of an oven according to the invention with two cable outlets.

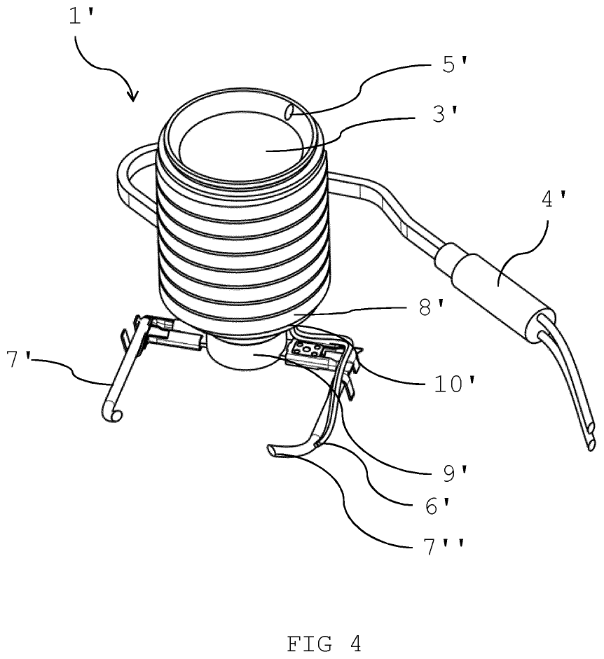

FIG. 4: the oven according to the invention from FIG. 3 without lateral insulation.

FIG. 1 shows a perspective view of an oven 1 according to the invention. The oven 1 comprises an insulation system consisting of two side half-shells 2a and 2b and a bottom insulation 2c. In this embodiment example, the insulation system forms the housing of the oven 1. The insulation half-shells 2a and 2b surround the insert 3. The insert 3 has a service opening 5 for checking the temperature. The insert is surrounded by the tubular cartridge (not shown). Connection lines 4 of the tubular cartridge extend to the side of the insulation 2a and 2b. A connection line 6 for a temperature sensor and two connection lines 7 for a temperature protection switch extend from the base insulation 2c.

FIG. 2 shows the oven 1 according to the invention from FIG. 1 without the insulation system. In addition to the insert 3 and the connecting lines 4, 6 and 7, the tubular cartridge 8 can now also be seen. The tubular cartridge 8 is wound around the insert in a spiral with 8 turns. The temperature protection switch 9 is located underneath the insert 3; the temperature sensor 10 is located on the side underneath the tubular cartridge 8.

FIG. 3 shows an alternative embodiment of an oven 1′ according to the invention. The oven 1′ has two cable outlets A and B. Both the cable outlet A and the cable outlet B have connection lines 7′ and 7″ for the temperature protection switch (9′ in FIG. 4). The connection line 6′ for the temperature sensor is provided at cable outlet B. The other elements are essentially identical to those in FIG. 1.

FIG. 4 shows the oven 1′ according to the invention from Figure 3 without insulation. Essential elements are identical to those in FIG. 2. The main difference between FIG. 4 and Figure 2 is that the two connection lines 7′ and 7″ for the temperature protection sensor are physically separated from each other.

1-16. (canceled)

17. An oven for an analytical system comprising a housing, an insulation system and an insert for a sample vessel, the insulation system is arranged at least partially around the insert, wherein at least one heating element is arranged between the insulation system and the insert and at least partially surrounding the insert.

18. The oven according to claim 17, wherein the at least one heating element is a tubular cartridge.

19. The oven according to claim 18, wherein the tubular cartridge is arranged in a spiral around the insert.

20. The oven according to claim 17, wherein the insert has an inner diameter of between 16 mm and 31 mm.

21. The oven according to claim 20, wherein the insert has an inner diameter of between 22 to 24 mm.

22. The oven according to claim 17, wherein the oven has an outer diameter of between 60 and 62 mm.

23. The oven according to claim 22, wherein the oven has an outer diameter of 61 mm.

24. The oven according to claim 17, wherein the oven has an external height of between 50 and 90 mm, preferably 51 and 88 mm and particularly preferably 55 and 56 mm, and an internal height of the insert in the range of 66 to 28 mm and preferably 33 mm.

25. The oven according to claim 24, wherein the oven has an external height of between 51 and 88 mm.

26. The oven according to claim 24, wherein the oven has an external height of between 55 and 56 mm.

27. The oven according to claim 24, wherein the oven has an internal height of 33 mm.

28. The oven according to claim 17, wherein the insert is made of a thermally conductive material.

29. The oven according to claim 28, wherein the thermal conductive material has a thermal conductivity higher than 10 W/(m*K).

30. The oven according to claim 17, wherein the insert has a wall thickness of 1 to 3 mm.

31. The oven according to claim 17, wherein the insert comprises a temperature sensor.

32. The oven according to claim 31, wherein the temperature sensor is arranged in a wall of the insert.

33. The oven according to claim 17, wherein the oven has a temperature protection switch.

34. The oven according to claim 33, wherein the temperature protection switch is arranged below the insert.

35. A titration system comprising at least one oven according to claim 17.

36. The titration system according to claim 35, wherein the titration system is a Karl-Fischer-titration system.

37. The titration system according to claim 36, wherein the system further comprises a sample changer and at least a first transfer system for transferring a sample from a sample rack to the at least one oven.

38. The titration system according to claim 35, wherein the system comprises at least a second transfer system for transferring a sample from the oven to a titration cell.

39. The titration system according to claim 35, wherein the system is at least partially automated.

40. The titration system according to claim 39, wherein the titration system is fully automated.

41. A titration method comprising the steps of:
providing a titration system according to claim 35,
providing a sample,
heating the sample with the oven,
titration of the sample.

42. The titration method according to claim 41 for determining a water content of a sample.

43. The titration method according to claim 41, wherein the method is a Karl-Fischer-titration method.
